(19) United States
(12) Patent Application Publication
(10) Pub. No.: US 2005/0097437 A1
(43) Pub. Date: May 5, 2005

(54) Data processing system and method

(75) Inventors: Stuart A. Green, Sheffield (GB); John Kendall Reid, Waterkloof (ZA)

Correspondence Address: WILMER CUTLER PICKERING HALE AND DORR LLP, 60 STATE STREET, BOSTON, MA, 02109, US

(73) Assignee: Zoo Digital Group Plc

(21) Appl. No.: 10/756,983

(22) Filed: Jan. 14, 2004

(30) Foreign Application Priority Data
Nov. 4, 2003 (GB) GB 0325705.2

(51) Int. Cl. G06F 15/00; G06F 17/21; G06F 17/00; G06F 17/24

(52) U.S. Cl. 715/500.1; 715/513; 715/506; 715/501.1; 715/512

(57) ABSTRACT

Embodiments of the present invention relate to a data processing system and method for use in creating an audiovisual product. The method, for example, comprises the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; and creating an audiovisual product in a predetermined output format, using the AV assets and the expanded intermediate data structure of the nodes and the links, wherein the audiovisual product is operable to facilitate random number generation.

### FIELD OF THE INVENTION

The present invention relates in general to a data processing method and system.

### BACKGROUND TO THE INVENTION

In general terms, it is desired to assemble many small sections of raw audio and video content (i.e. sound clips and video clips) to form a finished audiovisual product, by way of an authoring process. However, in many environments a considerable degree of specialist knowledge and time must be invested in the authoring process in order to achieve a desirable finished audiovisual product. These problems are exacerbated where the audiovisual product has a complex navigational structure or requires many separate raw content objects.

As a simple example, a feature movie or television program typically has a straightforward linear navigational sequence of individual scenes. By contrast, it is now desired to develop new categories of audiovisual products which have a much more complex navigational structure, such as a movie with many scene choices or different movie endings, and/or which have a large number of individual scenes, such as an interactive quiz game with say one thousand individual quiz questions.

An optical disc is a convenient storage media for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-video, DVD-audio, and DVD RAM, amongst others. Of these, DVD-video is particularly intended for use with pre-recorded video content, such as a motion picture. As a result of the large storage capacity and ease of use, DVD discs are becoming popular and commercially important. Conveniently, a DVD-video disc is played using a dedicated playback device with relatively simple user controls, and DVD players for playing DVD-video discs are becoming relatively widespread. More detailed background information concerning the DVD-video specification is available from DVD Forum at www.dvdforum.org.

Although DVD-video discs and DVD-video players are becoming popular and widespread, at present only a limited range of content has been developed. In particular, a problem arises in that, although the DVD specification is very flexible, it is also very complex. The process of authoring content into a DVD-video compatible format is relatively expensive and time consuming. In practice, the flexibility and functions allowed in the DVD-video specification are compromised by the expensive and time consuming authoring task. Consequently, current DVD-video discs are relatively simple in their navigational complexity. Such simplicity can impede a user's enjoyment of a DVD-video disc, and also inhibits the development of new categories of DVD-video products.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-video product must be explicitly defined by the author. Hence, creating a DVD-video product with a complex navigational structure is expensive, time-consuming and error-prone.

Many computer applications call for the use of random numbers, which are employed to give unpredictability to the behaviour of a program. Many computer platforms provide a so-called random number generator, which is typically a RND(N) function that returns a random number in the range of 0 to N−1 (or sometimes 1 to N). It will be appreciated by those skilled in the art that the word “random” is a misnomer since the random numbers produced are usually created using a linear congruential generator (LCG). An LCG sequence generator calculates a series of numbers, rᵢ, of the form rᵢ₊₁=F(rᵢ). Successive numbers in the number sequence are a function of previous numbers. If the RND(N) function performs fairly, each invocation of the function should yield values 0 to N−1 with equal probability. Typical, an LCG will have a large period (that is, the sequence will produce a large number of values before it repeats) . If an application requires RND(N), where N is relatively small, then the output of the LCG is manipulated to yield a value that lies in the range 0 to N−1. For example, the result of each step of the LCG can be taken to modulo n in order to produce values in the required range. As a consequence, repeated calls of RND(N) can return repetitions of values before N values have been returned.

The DVD-Video specification as published by the DVD Forum supports a random number function, RND[N], to return a random number within a specified range. However, the specification does not contain any explicit technical guidance to implement this function. It is well known within the industry that some manufacturers have implemented the function in a way that their DVD players always generate the same random number sequence. Such a situation can occur when an LCG is seeded with a constant value. Consequently, companies engaged in authoring DVD-Video discs cannot assume that a different random number sequence will be generated each time a disc is played. This is particularly problematical for games, such as quizzes, where, for some devices, it can result in the same question sequence being delivered each time the disc is played.

Another feature of DVD-Video is the counter mode of the GPRM registers. A GPRM can be placed in counter mode such that its value is incremented by one for each elapsed second from the moment the counter mode is invoked. This feature can be used effectively to seed an LCG with a value that is time-dependent and likely to change as between successive plays of a disc. While this may go some way to overcoming the limitation of players that have a deficient RND implementation, some manufacturers have defective implementations of the counter feature such that registers are incorrectly incremented in contrast to the DVD-Video specification requirements. Furthermore, it is known that there are some DVD players that have defective implementations of both the RND function and the counter mode of the GPRMs.

It is an object of embodiments of the present invention at least to mitigate some of the problems of the prior art.

### SUMMARY OF INVENTION

In a first aspect of the present invention there is provided an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; and creating an audiovisual product in a predetermined output format, using the AV assets and the expanded intermediate data structure of the nodes and the links; wherein the audiovisual product is operable to facilitate random number generation.

In one preferred embodiment, the present invention relates to authoring of audiovisual content into a form compliant with a specification for DVD-video and able to be recorded on an optical disc recording medium.

In a second aspect of the present invention there is provided an authoring method for use in creating a DVD-video product, comprising the steps of: creating a plurality of components representing parameterised sections of audiovisual content, and a plurality of transitions representing movements between components; expanding the plurality of components and the plurality of transitions to provide a set of AV assets and an expanded data structure of nodes and links, where each node is associated with an AV asset of the set and the links represent movement from one node to another; and creating a DVD-video format data structure from the AV assets, using the nodes and links, wherein the audiovisual product is operable to facilitate random number generation.

In a third aspect of the present invention there is provided an authoring method for use in creating an audiovisual product according to a DVD-video specification, comprising the steps of: generating a set of AV assets each comprising a video object, zero or more audio objects and zero or more sub-picture objects, and an expanded data structure of nodes and links, where each node is associated with one AV asset of the set and the links represent navigational movement from one node to another; and creating a DVD-video format data structure from the set of AV assets, using the nodes and links; the method characterised by the steps of: creating a plurality of components and a plurality of transitions, where a component implicitly defines a plurality of AV assets by referring to a presentation template and to items of raw content substitutable in the presentation template, and the plurality of transitions represent navigational movements between components; and expanding the plurality of components and the plurality of transitions to generate the set of AV assets and the expanded data structure of nodes and links, wherein the audiovisual product is operable to at least facilitate random number generation.

In another aspect the present invention there is provided a recording medium having recorded thereon computer executable instructions for performing any of the methods defined herein.

In yet another aspect of the present invention there is provided a recording medium having recorded thereon an audiovisual product authored according to any of the methods defined herein.

Advantageously, embodiments can provide a convenient and simple method and apparatus for authoring an audio-visual product.

Preferred embodiments provide a method and apparatus able to create an audio-visual product having a complex navigational structure and/or having many individual content objects, whilst reducing a time required for authoring and minimising a need for highly skilled operators.

Preferably, there is provided an authoring tool which is intuitive to use and is highly flexible.

Particularly preferred embodiments support creation of audio-visual products such as DVD-video products that run on commonly available DVD-video players.

Accordingly, a still further aspect of embodiments of the present invention provides a data processing system comprising means for playing an interruptible or skipable video sequence; and a random number generator for generating a random number associated with an interruption of the interruptible or skipable video sequence.

Advantageously, embodiments of the present invention allow a DVD implementation independent random number generator to be realised that is not beset with at least some of the above mentioned problems.

A further aspect of embodiments of the present invention provides a data processing system comprising a reader to read data representing a video sequence and a number of associated data each having a corresponding command; a presentation engine for outputting the video sequence derived from the data representing the video sequence, a navigation engine, responsive to an event, to invoke one of the corresponding commands according to the output of the video sequence; and means to derive a first value from the invoked command of the corresponding commands. It will be appreciated that the reader might form part of a DVD player or DVD drive to read data from a DVD.

A still further aspect of embodiments of the present invention provides a storage medium comprising data representing a video sequence and a number of associated data each having a corresponding command; and data to derive a first value from one of the corresponding commands in response to an event. Preferably, the storage medium is a DVD.

Other features of the invention are described below and claimed in the claims.

### BRIEF DESCRIPTION OF THE DRAWINGS

Embodiments of the present invention will now be descried, by way of example only, with reference to the accompanying drawings in which:

FIG. 1 is an overview of an authoring method according to a preferred embodiment;

FIG. 2 is a schematic diagram showing a simple abstraction of a desired audiovisual product;

FIG. 3 shows in more detail a component used as part of the abstraction of FIG. 2;

FIG. 4 illustrates an example prior art authoring method compared with an example preferred embodiment;

FIG. 5 depicts another example embodiment of the present authoring method using components and transitions;

FIG. 6 shows the example of FIG. 5 in a tabular format;

FIG. 7 is an overview of a method for evaluating components and transitions;

FIG. 8 depicts evaluation of components in more detail;

FIG. 9 shows evaluation of transitions in more detail;

FIG. 10 illustrates a portion of an expanded data structure during evaluation of components and transitions;

FIG. 11 is an overview of a preferred method for creating DVD-video structures from an expanded data structure;

FIG. 12 shows a step of creating DVD video structure locations in more detail;

FIG. 13 depicts a step of creating DVD-video compatible data structures in more detail;

FIG. 14 shows a skipable sequence according to an embodiment of the present invention; and

FIG. 15 depicts a flowchart according to an embodiment.

### DETAILED DESCRIPTION OF THE PREFERRED EMBODIMENTS

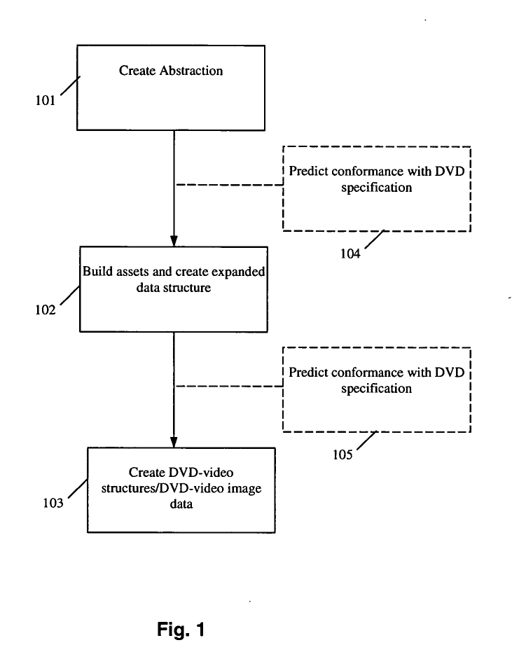

FIG. 1 shows an overview of at least part of an authoring method according to a preferred embodiment of the present invention. The embodiments of the present invention are applicable when authoring many types of audiovisual content or products, and in particular when complex navigational structure or content are involved.

As one example, embodiments of the present invention are applicable to authoring of video-on-demand products delivered remotely from a service provider to a user, such as over a computer network or other telecommunications network. Here, the embodiments of present invention are especially useful in authoring interactive products, where user choices and responses during playback of the product dictate navigational flow or content choices.

As another example, embodiments of the present invention are particularly suitable for use in the authoring of an audiovisual product or audio visual content compliant with a DVD-video specification. This example will be discussed in more detail below in order to illustrate the preferred arrangements of present invention. The audiovisual product can be, for example, recorded onto a medium such as an optical disk or magnetic medium. The DVD-video specification defines a series of data objects that are arranged in a hierarchical structure, with strict limits on the maximum number of objects that exist at each level of the hierarchy. Hence, in one preferred embodiment of the present invention it is desired to create an audiovisual product or audiovisual content which meets these and other limitations of the specification. In particular it is desired that the resultant audiovisual product will play on commonly available DVD players. However, it is also desired to create the audiovisual product having a complex navigational structure, to increase a user's enjoyment of the product, and in order to allow the creation of new categories of audiovisual products.

In the field of DVD-video, audiovisual content is considered in terms of audio-visual assets (also called AV assets or presentation objects) . According to the DVD-video specification each AV asset contains at least one video object, zero or more audio objects, and zero or more sub-picture objects. That is, a section of video data is presented along with synchronised audio tracks and optional sub-picture objects. The current DVD-video specification allows up to eight different audio tracks (audio streams) to be provided in association with up to nine video objects (video streams). Typically, the video streams represent different camera angles, whilst the audio streams represent different language versions of a soundtrack such as English, French, Arabic etc. Usually, only one of the available video and audio streams is selected and reproduced when the DVD-video product is played back. Similarly, the current specification allows up to thirty-two sub-picture streams, which are used for functions such as such as language subtitles. Again, typically only one of the sub-picture streams is selected and played back to give, for example, a movie video clip with English subtitles from the sub-picture stream reproduced in combination with a French audio stream. Even this relatively simple combination of video, audio and sub-picture streams requires a high degree of coordination and effort during authoring to achieve a finished product such as a feature movie. Hence, due to the laborious and expensive nature of the authoring process there is a strong disincentive that inhibits the development of high-quality audiovisual products or content according to the DVD-video specification. There is then an even stronger impediment against the development of audiovisual products or content with complex navigational flow or using high numbers of individual raw content objects.

Conveniently, the authoring methods of embodiments of the present invention are implemented as a program or a suite of programs. The program or programs are recorded or stored on or in any suitable medium, including a removable storage such as a magnetic disk, hard disk or solid state memory card, or as a signal modulated onto a carrier for transmission on any suitable data network, such as the Internet.

In use, the authoring method is suitably performed on a computing platform, like a general purpose computing platform such as a personal computer or a client-server computing network. Alternatively, the method may be implemented, wholly or at least in part, by dedicated authoring hardware.

As shown in FIG. 1, the authoring method of the preferred embodiment of the present invention comprises three main stages, namely: creating a high-level abstraction (or storyboard) representing functional sections of a desired audiovisual product in step 101; automatically evaluating the high-level abstraction to create a fully expanded intermediate structure and a set of AV assets in step 102; and creating an output data structure compliant with a DVD-video specification using the expanded intermediate structure and AV assets in step 103. Preferably, the output data structure can then recorded onto a recording medium, such as, for example, a digital linear tape that can be used, to create a DVD-video product using glass master created using the content of the digital linear tape.

The method outlined in FIG. 1 will now be explained in more detail.

Firstly, looking at the step 101 of FIG. 1, the high-level abstraction is created by forming a plurality of components that implicitly represent functional elements of a desired DVD-video product, and a set of transitions that represent movements, that is, navigation, between the components that will occur during playback.

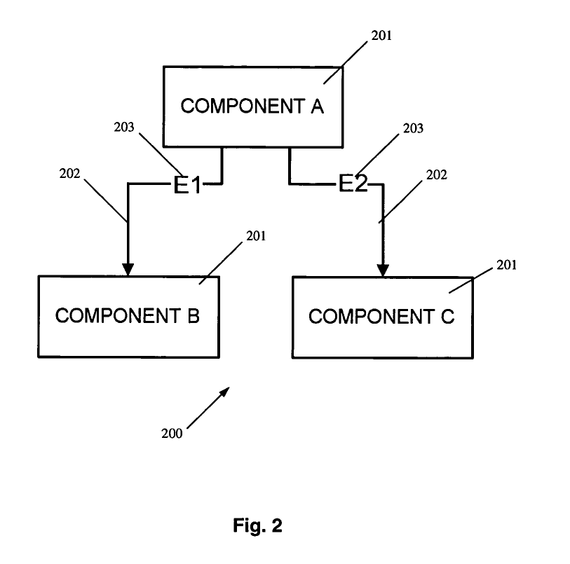

FIG. 2 is a schematic diagram showing a simple abstraction of a desired audiovisual product. In the example of FIG. 2 there are three components 201, linked by two transitions 202. The components 201 represent functional elements of the desired audiovisual product, where one or more portions of AV content (combinations of video clips, audio clips, etc) are to be reproduced during playback. The transitions 202 indicate legitimate ways of moving from one component to another during playback. In the example of FIG. 2, the transitions 202 are all explicitly defined. Suitably, each transition 202 is associated with an event 203, which indicates the circumstances giving rise to that transition. An event 203 is a triggering action such as the receipt of a user command, or the expiry of a timer, that influences movement through the sections of AV content during playback. Referring to FIG. 2, starting from a particular component A, and given all possible actions, exactly one event 203 will be satisfied, allowing a transition 202 from the current component A to a next component B or C.

The preferred embodiments provide three different types of component. These are an information component, a choice component and a meta-component.

An information component represents what will in due course become a single AV asset in the desired audiovisual product. Suitably, an information component simply comprises a reference to a raw content object or collection of raw content objects (i.e. raw video and audio clips, image stills or other digital content) that will be used to create an AV asset in the audiovisual product. For example, an information component refers to a welcome sequence that is displayed when the DVD-video product is played in a DVD-video player. The same welcome sequence is to be played each time playback begins. It is desired to display the welcome sequence, and then proceed to the next component. An information component (which can also be termed a simple component) is used principally to define presentation data in the desired DVD-video product.

A choice component represents what will become a plurality of AV assets in the desired audiovisual product. In the preferred embodiment, the choice component (alternately termed a multi-component) comprises a reference to at least one raw content object, and one or more parameters. Here, for example, it is desired to present a welcome sequence in one of a plurality of languages, dependent upon a language parameter. That is, both a speaker's picture (video stream) and voice track (audio stream) are changed according to the desired playback language. Conveniently, a choice component is used to represent a set of desired AV assets in the eventual audiovisual product, where a value of one or more parameters is used to distinguish between each member of the set. Hence, a choice component represents mainly presentation data in a desired DVD-video product, but also represents some navigational structure (i.e. selecting amongst different available AV assets according to a language playback parameter).

A meta-component comprises a procedurally-defined structure representing a set of information components and/or a set of choice components, and associated transitions. Conveniently, a meta-component may itself define subsidiary meta-components. A meta-component is used principally to define navigational structure in the desired audiovisual product by representing other components and transitions.

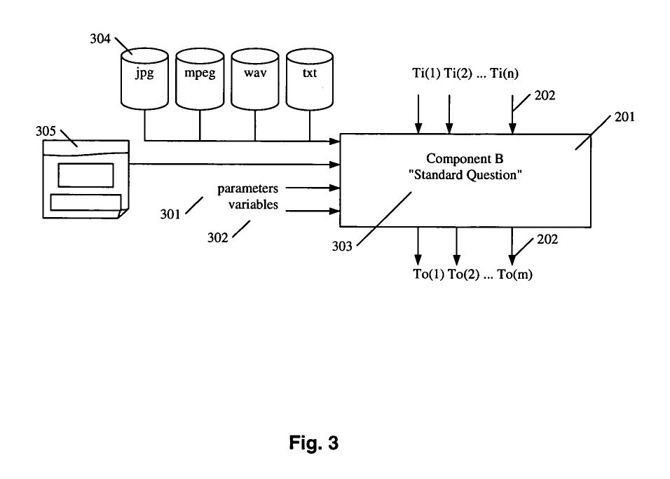

FIG. 3 shows a choice component or information component 201 in more detail. The component is reached by following one of a set of incoming transitions 202, labelled Ti(1 . . . n), and is left by following one of a set of outgoing transitions To(1 . . . m). The set of incoming transitions 202 might comprise one or more than one incoming transition. The set of outgoing transitions might comprise one or more than one outgoing transition.

The component 201 is defined with reference to zero or more parameters 301, which are used only during the authoring process. However, the component 201 may also be defined with reference to zero or more runtime variables 302. Each variable 302 records state information that can be read and modified within the scope of each component, during playback of the audiovisual product such as in a standard DVD player. Conveniently, the component 201 is provided with a label 303 for ease of handling during the authoring process.

The component 201 contains references to one or more items of content 304. The items of content are raw multi-media objects (still picture images, video clips, audio clips, text data, etc.) recorded in one or more source storage systems such as a file system, database, content management system, or asset management system, in any suitable format such as, for example, .gif, .tif, .bmp, .txt, .rtf, .jpg, .mpg, .qtf, mov, .wav, .rm, .qtx, amongst many others. It will be appreciated that these raw content objects are not necessarily at this stage in a format suitable for use in the DVD-video specification, which demands that video, audio and sub-picture objects are provided in selected predetermined formats (i.e. MPEG).

Each component 201 uses the references as a key or index which allows that item of content to be retrieved from the source storage systems. The references may be explicit (e.g. an explicit file path), or may be determined implicitly, such as with reference to values of the parameters 301 and/or variables 302 (i.e. using the parameters 301 and/or variables 302 to construct an explicit file path).

Conveniently, the component 201 also preferably comprises a reference to a template 305. The template 305 provides, for example, a definition of presentation, layout, and format of a desired section of AV content to be displayed on screen during playback. A template 305 draws on one or more items of content 304 to populate the template. Typically, one template 305 is provided for each component 201. However, a single template 305 may be shared between a number of components 201 or vice versa. A template 305 is provided in any suitable form, such as, for example. As an executable program, a plug-in or an active object. A template is conveniently created using a programming language such as C++, Visual Basic, Shockwave or Flash, or by using a script such as HTML or Python, amongst many others. Hence, it will be appreciated that a template allows a high degree of flexibility in the creation of AV assets for a DVD-video product. Also, templates already created for other products (such as a website) may be reused directly in the creation of another form of audiovisual product, in this case a DVD-video product content.

The parameters 301, runtime variables 302, content items 304 and template 305 together allow one or more AV assets to be produced for use in the desired audiovisual product. Advantageously, creating a component 201 in this parameterised form allows a number, which might be a large number, large plurality of AV assets to be represented simply and easily by a single component.

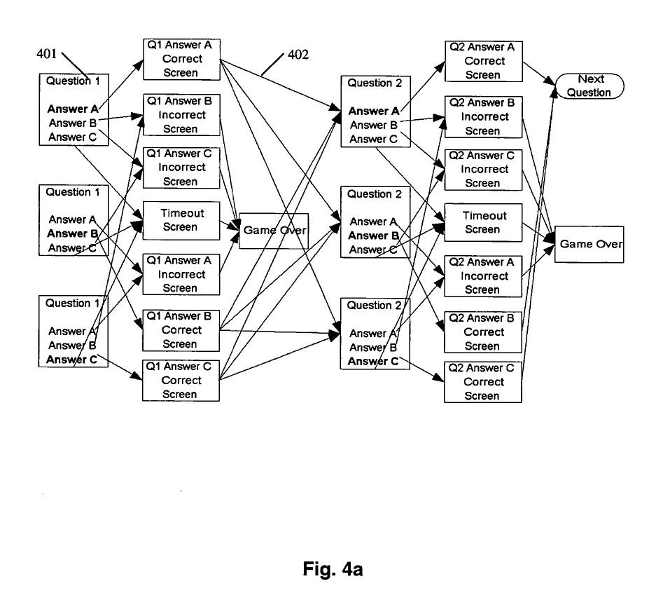

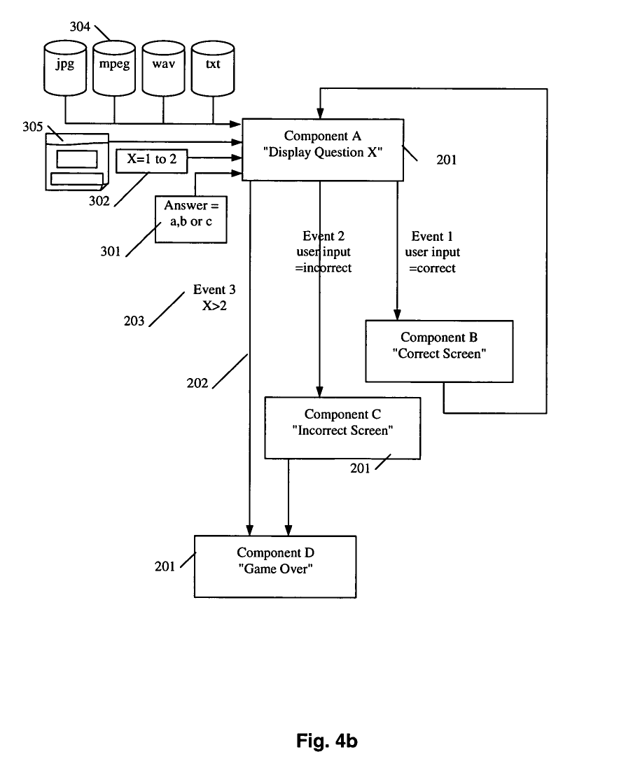

To illustrate the power and advantages of creating components 201 and transitions 202 as described above, reference will now be made to FIG. 4 which compares a typical prior art method for authoring an audiovisual product against preferred embodiments of the present invention. In this example, it is desired to develop an audiovisual product which allows the user to play a simple quiz game.

In FIG. 4a, each AV asset 401 which it is desired to present in the eventual audiovisual product must be created in advance and navigation between the assets defined using navigation links represented by arrows 402. Here, the game involves answering a first question and, if answered correctly, then answering a second question. The answer to each question is randomised at runtime using a runtime variable such that one of answers A, B and C is correct, whilst the other two are incorrect. In this simple example of FIG. 4a it can be seen that a large number of assets need to be created, with an even greater number of navigational links. Hence, the process is relatively expensive and time consuming, and is prone to errors.

FIG. 4b shows an abstraction, using components and transitions as described herein, for an equivalent quiz game. It will be appreciated that the abstraction shown in FIG. 4b remains identical even if the number of questions increases to ten, twenty, fifty or some other number of questions, whereas the representation in FIG. 4a becomes increasingly complex as each question is added.

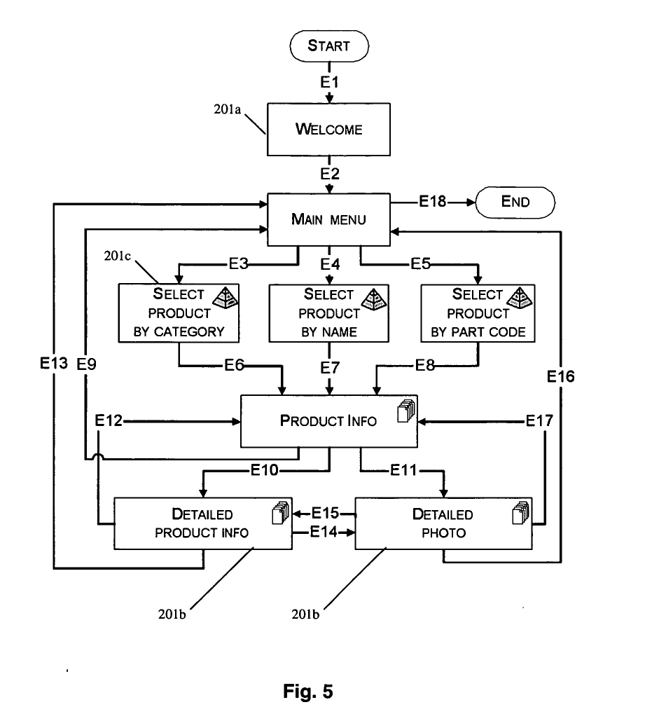

FIG. 5 shows another example abstraction using components and transitions. FIG. 5 illustrates an example abstraction for an audiovisual product that will contain a catalogue of goods sold by a retail merchant. A welcome sequence is provided as an information component 201a. Choice components 201b are used to provide a set of similar sections of AV content such as summary pages of product information or pages of detailed product information including photographs or moving video for each product in the catalogue. Here, the catalogue contains, for example, of the order of one thousand separate products, each of which will result in a separate AV asset in the desired DVD-video product. Meta-components 201c provide functions such as the selection of products by category, name or by part code. These meta-components are procedurally defined.

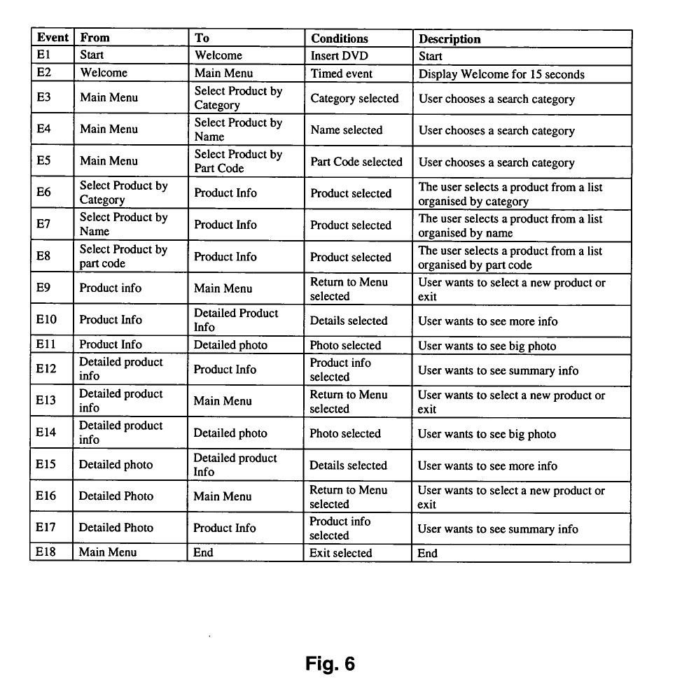

FIG. 6 shows a tabular representation for the abstraction shown in schematic form in FIG. 5.

In use, the authoring method and apparatus suitably presents a convenient user interface for creating components and transitions of the high-level abstraction. Ideally, a graphical user interface is provided allowing the definition of components, transitions and events, similar to the schematic diagram of FIG. 5. Most conveniently, the user interface provides for the graphical creation of components such as by drawing boxes and entering details associated with those boxes, and defining transitions by drawing arrows between the boxes and associating events with those arrows. Alternatively, a tabular textual interface is provided similar to the table of FIG. 6.

Referring again to FIG. 1, the abstraction created in step 101 is itself a useful output. The created abstraction may be stored for later use or may be transferred to another party for further work. However, in most cases the authoring method is used to automatically create a final audiovisual product, such as a DVD-video product, from the abstraction.

Referring to FIG. 1, the method optionally includes the step 104 of checking for compliance with a DVD specification. It is desired to predict whether the resulting DVD-video product will conform to a desired output specification, in this case the DVD-video specification. For example, the DVD-video specification has a hierarchical structure with strict limits on a maximum number of objects that may exist at each level, and limits on the maximum quantity of data that can be stored on a DVD-video disc.

In one embodiment, the checking step 104 is performed using the created components 201 and transitions 202. As discussed above, the components 201 contain references to raw AV content objects 304 and templates 305, and authoring parameters 301, 302, that allow AV assets to be produced. The checking step 104 comprises predicting a required number of objects at each level of the hierarchical structure, by considering the number of potential AV assets that will be produced given the possible values of the authoring parameters (i.e. authoring-only parameters 301 and runtime variables 302), and providing an indication of whether the limits for the maximum number of objects will be exceeded. Similarly, where a component defines a set of similar AV assets, then it is useful to predict the physical size of those assets and to check that the audiovisual product is expected to fit within the available capacity of a DVD disc. Advantageously, the conformance check of step 104 is performed without a detailed realisation of every AV asset, whilst providing an operator with a reasonably accurate prediction of expected conformance. If non-conformance is predicted, the operator may then take steps, at this early stage, to remedy the situation. As a result, it is possible to avoid unnecessary time and expense in the preparation of a full audiovisual product which is non-conformant.

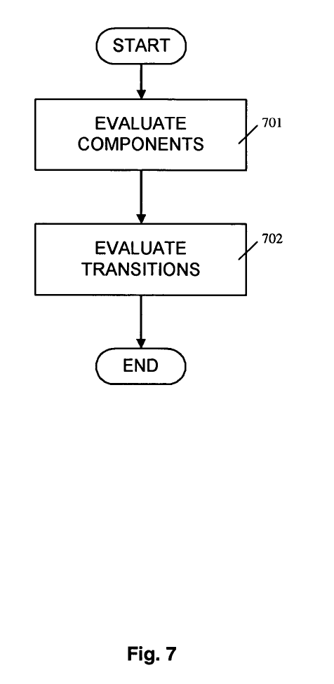

As shown in FIG. 1, in step 102 the components 201 and transitions 202 of the high level abstraction 200 are automatically evaluated and expanded to create AV assets and an intermediate data structure of nodes and links. FIG. 7 shows the step 102 of FIG. 1 in more detail.

The components 201 and transitions 202 may be evaluated in any order. However, but it is convenient to first evaluate the components and then to evaluate the transitions. Ideally, any meta-components in the abstraction are evaluated first. Where a meta-component results in new components and transitions, these are added to the abstraction until all meta-components have been evaluated, leaving only information components and parameterised choice components.

An expanded intermediate data structure is created to represent the abstract components 201 and transitions 202 in the new evaluated form. This expanded data structure comprises branching logic derived from the events 203 attached to the transitions 202 (which will eventually become navigation data in the desired audiovisual product) and nodes associated with AV assets derived from the components 201 (which will eventually become presentation data in the audiovisual product). However, it is not intended that the expanded data structure is yet in a suitable form for creating an audiovisual product in a restricted format such as a DVD-video product, since at this stage there is no mapping onto the hierarchical structure and other limitations of the DVD-video specification.

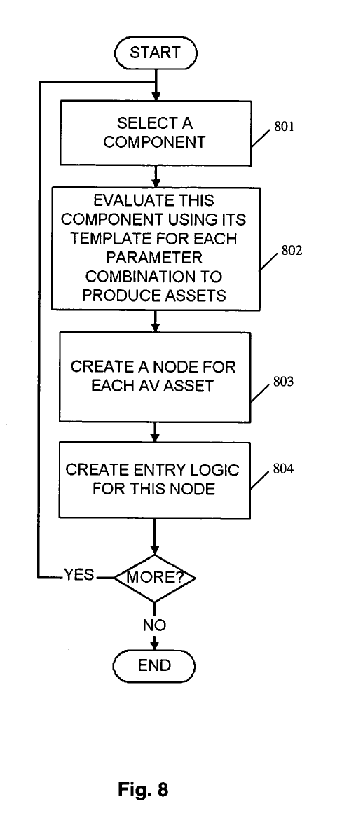

FIG. 8 shows step 701 of FIG. 7 in more detail, to explain the preferred method for evaluating the components 201. As shown in FIG. 8, each information component 201a and each choice component 201b is selected in turn in step 801. Each component 201 is evaluated to provide one or more AV assets in step 802. In an information component, this evaluation comprises creating an AV asset from the referenced raw content objects 304. In a choice component, this evaluation step comprises evaluating a template 305 and one or more raw content objects 304 according to the authoring parameters 301/302 to provide a set of AV assets. Suitably, a node in the expanded data structure is created to represent each AV asset, at step 803. At step 804, entry logic 132 and/or exit logic 134 is created to represent a link to or from each node such that each AV asset is reached or left under appropriate runtime conditions.

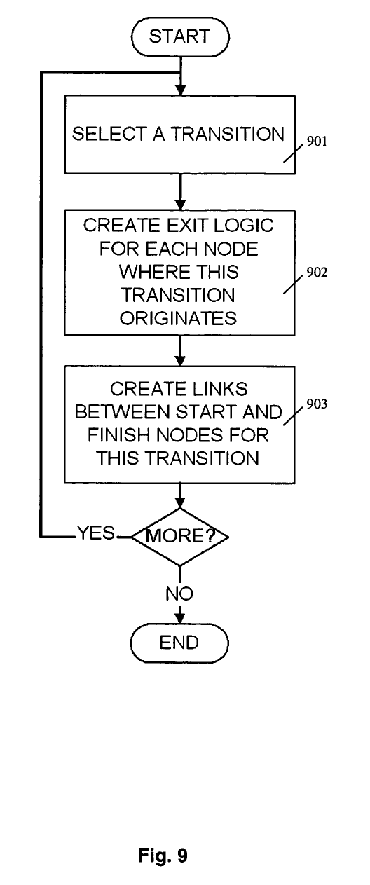

FIG. 9 shows a preferred method for evaluating transitions in step 702 of FIG. 7. Each transition 202 is selected in any suitable order in step 901. In step 902 the conditions of the triggering event 203 associated with a particular transition 202 are used to create entry and/or exit logic for each node of the expanded data structure. In step 903, explicit links are provided between the nodes.

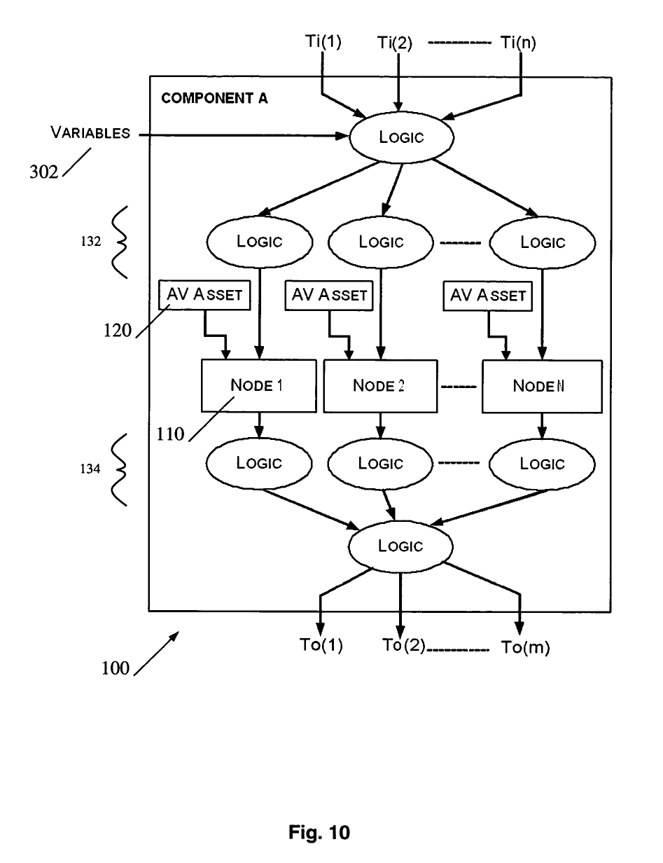

FIG. 10 is a schematic illustration of a component 201 during evaluation to create a set of nodes 110 each associated with an AV asset 120, together with entry logic 132 and exit logic 134, defining movement between one node 110 and the next. The entry logic 132 and exit logic 134 reference runtime variables 302 which are available during playback (e.g. timer events, player status, and playback states), and the receipt of user commands. Conveniently, the evaluation step consumes each of the authoring-only parameters 301 associated with the abstract components 201, such that only the runtime variables 302 and runtime actions such as timer events and user commands remain.

Referring again to FIG. 1, a conformance checking step 105 may, additionally or alternatively to the checking step 104, be applied following the evaluation step 102. Evaluation of the abstraction in step 102 to produce the expanded data structure 100 allows a more accurate prediction of expected compliance with a particular output specification. In particular, each node of the expanded data structure represents one AV asset, such that the total number of AV assets and object locations can be accurately predicted, and the set of AV assets has been created, allowing an accurate prediction of the capacity required to hold these assets. Conveniently, information about conformance or non-conformance is fed back to an operator. Changes to the structure of the product can then be suggested and made in the abstraction to improve compliance.

Referring to FIG. 1, in step 103 the expanded data structure from step 102 is used to create an audiovisual product according to a predetermined output format, in this case by creating specific structures according to a desired DVD-video specification.

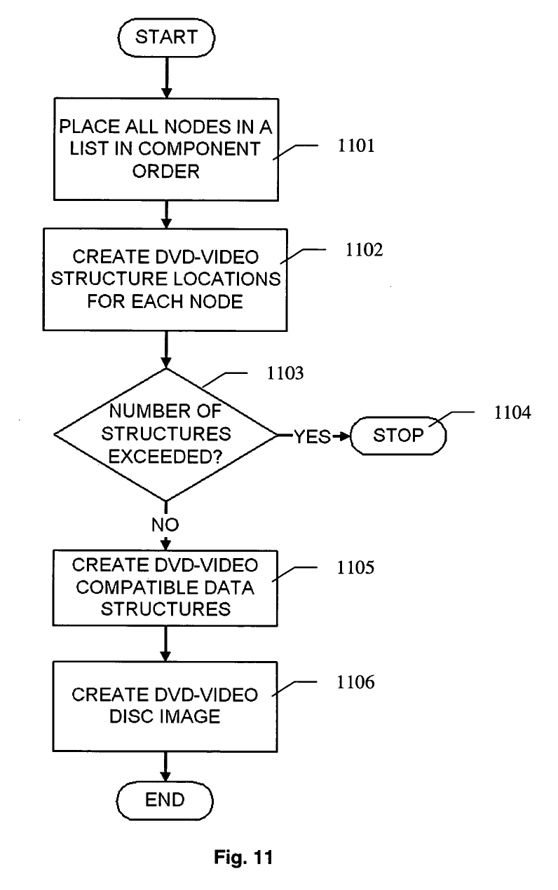

FIG. 11 shows an example method for creation of the DVD video structures. In step 1101, the nodes 110 in the expanded data structure are placed in a list, such as in an order of the abstract components 201 from which those nodes originated, and in order of the proximity of those components to adjacent components in the abstraction. As a result, jumps between DVD video structure locations during playback are minimised and localised to improve playback speed and cohesion.

Each node is used to create a DVD video structure location at step 1102. Optionally, at step 1103 if the number of created DVD video structure locations exceeds the specified limit set by the DVD-video specification then creation is stopped at 1104 and an error reported. Assuming the number of structures is within the specified limit then DVD video compatible data structures are created at step 1105. Finally, a DVD video disc image is created at step 1106. Conveniently, commercially available tools are used to perform step 1106 and need not be described in detail here.

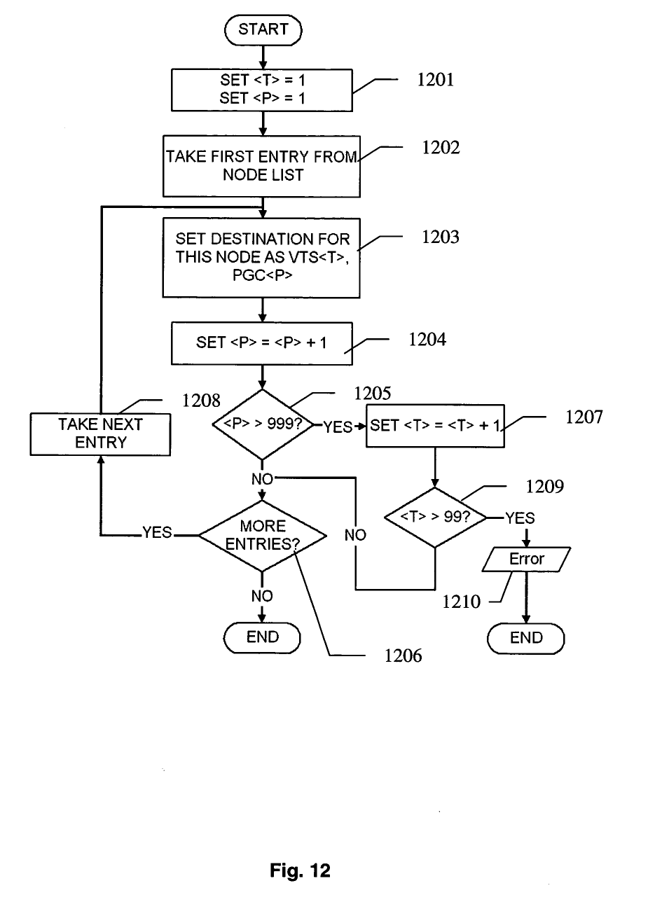

Step 1102 is illustrated in more detail in FIG. 12. In this example variable T represents a number of a video title set VTS (ie. from 1-99) whilst variable P represents a program chain PGC (ie. from 1-999) within each video title set. As shown in FIG. 12, the nodes 110 of the expanded data structure 100 are used to define locations in the video title sets and program chains. As the available program chains within each video title set are consumed, then the locations move to the next video title set. Here, many alternate methods are available in order to optimise allocation of physical locations to the nodes of the expanded data structure.

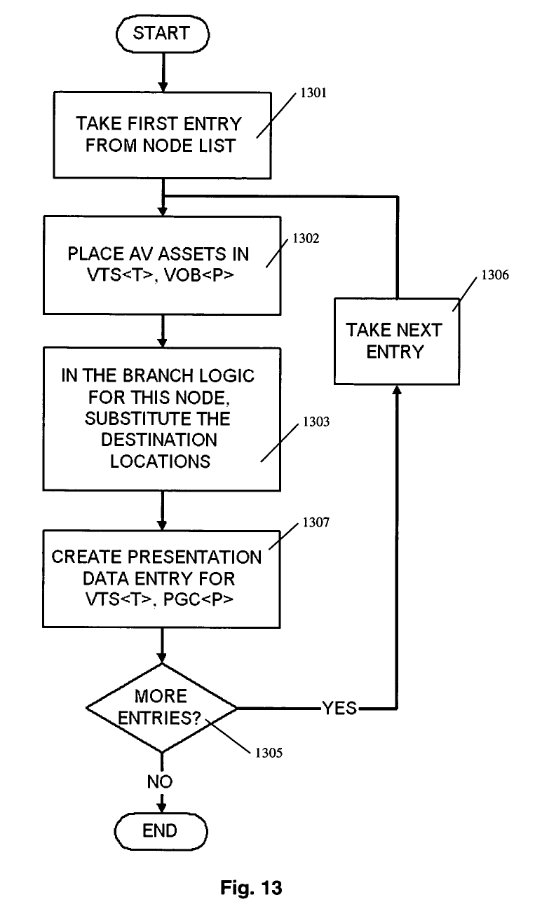

Step 1105 of FIG. 11 is illustrated in more detail in FIG. 13. FIG. 13 shows a preferred method for creating DVD-video compatible data structures by placing the AV assets 120 associated with each node 110 in the structure location assigned for that node and substituting links between the nodes with explicit references to destination locations. At step 1307 this results in an explicit DVD compatible data structure which may then be used to create a DVD disc image. Finally, the DVD disc image is used to record a DVD disc as a new audiovisual product.

The DVD authoring method and apparatus described above have a number of advantages. Creating components that represent parameterised sections of audio visual content allow many individual AV assets to be implicitly defined and then automatically created. Repetitive manual tasks are avoided, which were previously time consuming, expensive and error-prone. The authoring method and apparatus significantly enhance the range of features available in existing categories of audiovisual products or content such as movie presentations. They also allow new categories of audiovisual products or content to be produced. These new categories include both entertainment products or content such as quiz-based games and puzzle-based games, as well as information products such as catalogues, directories, reference guides, dictionaries and encyclopaedias. In each case, the authoring method and apparatus described herein allow full use of the video and audio capabilities of DVD specifications such as DVD-video. A user may achieve playback using a standard DVD player with ordinary controls such as a remote control device. A DVD-video product having highly complex navigational content is readily created in a manner that is simple, efficient, cost effective and reliable.

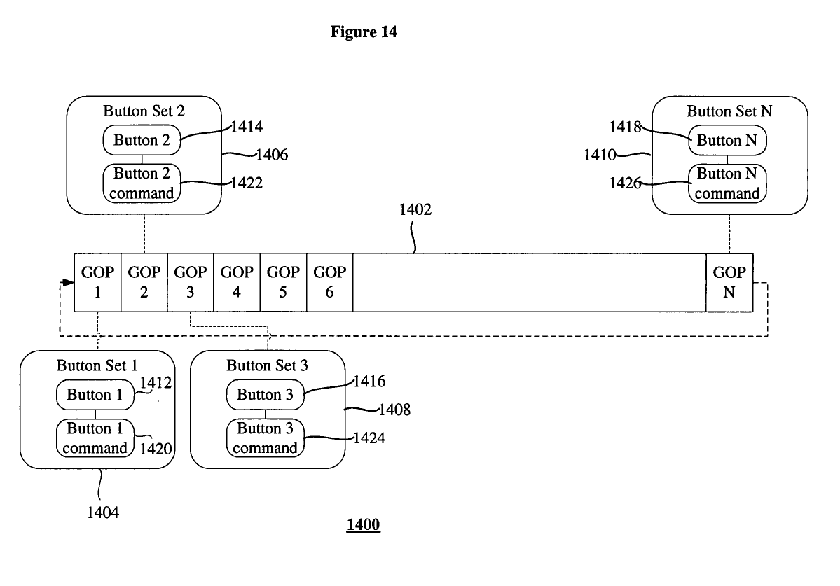

FIG. 14 shows an assembly of data structures 1400 used by embodiments of the present invention. The assembly of data structures 1400 represents an embodiment of explicitly realised AV assets as described above. The assembly 1400 comprises an interruptible or skipable video sequence 1402 having a number of group-of-pictures structures GOP 1 to GOP N. It will be appreciated that the skipable video sequence 1402 will have been derived from an associated source video sequence. The associated source video sequence represents an embodiment of one or more raw content objects described above. Each group-of-pictures structure GOP 1 to GOP N has an associated button set 1404 to 1410. Each button set 1404 to 1410 comprises a respective active button 1412 to 1418. Each button set 1412 to 1418 has an associated button command 1420 to 1426 that is performed in response to a navigation engine (not shown) detecting invocation of a respective active button 1412 to 1418. At least any one of, and, preferably, all of, the button sets 1404 to 1410, respective active buttons 1412 to 1418 and associated button commands 1420 to 1426 represent embodiments of the explicitly realised AV asset data described above. The video sequence 1402 preferably also has an associated entry link or reference to the sequence for use by, for example, the navigation and presentation engines in accessing and outputting that video sequence and, preferably, an associated exit link or reference to allow a subsequent video sequence to be accessed. It will be appreciated that the associated entry and exit links or references represent embodiments of at least parts of the expanded intermediate data structure of at least one node and at least one link described above.

The video sequence 1402 and corresponding button sets 1404 to 1410 are arranged such that only the button set associated with a currently active or currently playing or processed group-of-pictures structure is able to be invoked. Therefore, for example, the first button set 1404 is active during processing of the first group-of-pictures structure GOP 1 and so on. The button sets 1404 to 1410 are arranged so that, upon generation of a user event, such as, for example, the user depressing the “OK” button of a remote control (not shown), the corresponding button command 1420 to 1426 is invoked.

Prior to playing the initial video sequence 1402, one of the GPRMs (not shown) is initialised using a value. Preferably, the initialisation value is a random value generated using, for example, the inherent RND function provided by DVD players. The initialised GPRM is then set to counter mode. This second step of setting the GPRM to counter mode is optional.

A button command has the following format
ADD<GPRM><value>; LNK<next-sequence>.

This command results in adding the value represented by <value> to the content of register <GPRM>, that is, the register initialised using the random value, and then linking or jumping to the next or a further video sequence identified by <next-sequence>. Preferably, the value of <value>is unique or distinct for each button set of the sequence. In an embodiment, the values chosen for <value> are the same as the GOP numbers. Therefore, for example, assuming the user presses “OK” during the processing or playing of the first group of pictures structure GOP1, the value 1 is added to the GPRM, during the second group-of-pictures structure GOP2, the value 2 is added to the GPRM and so on. Alternatively, the values used for <value> can be non-sequential or, themselves, random numbers.

Preferably, the video sequence 1402 is arranged to repeat, which will force the user to press “OK” to advance the programme and a post command is added to the sequence in the form
ADD<GPRM><value2>,
where <GPRM> is the register initialised previously and <value2> is a further number added to the content of the GPRM upon repetition of the sequence.

If, as is the case in preferred embodiments, the values associated with the button commands are sequential and start from the value “1”, it will be appreciated that the value for the mth GOP has the value m. It will be appreciated that ADD<GPRM><value2> is a command that is executed each time the whole of the video sequence 1402 has been played.

When a random number is subsequently required, the previously initialised GPRM is returned to normal register mode and its current value is used as the random number. It will be appreciated that since the point at which a user chooses to skip the video sequence might vary as between plays, it will, typically, result in a different value being contained within the GPRM even on devices that have defective implementations of the RND function and defective register counting mode implementations.

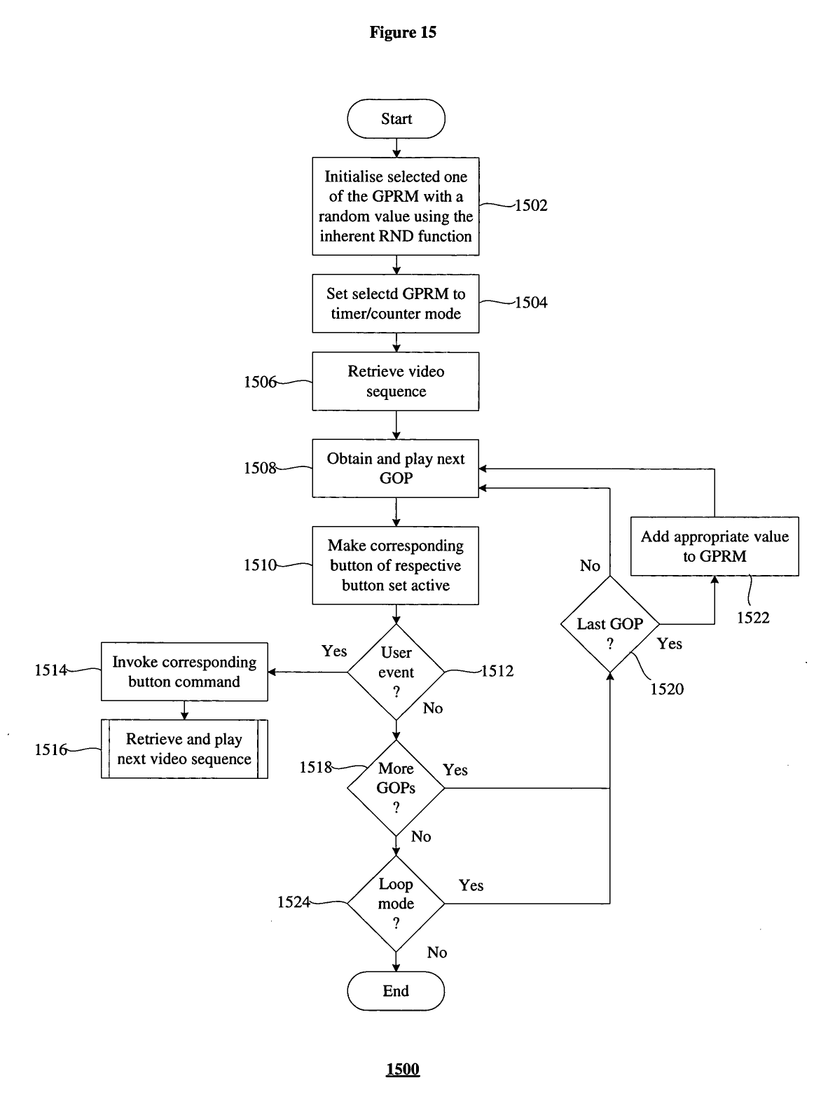

Referring to FIG. 15, there is shown a flowchart 1500 of the steps performed by an embodiment of the present invention. One of the GPRM registers is selected and initialised with a random value using the inherent RND function at step 1502. At step 1504, the selected GPRM register is set to counter mode. At step 1506, the video sequence is played by processing the first, or next, GOP structure to produce the video sequence or, at least, part of a video sequence by the navigation and presentation engines (not shown) as is conventional within a DVD player. At step 1510, which is performed, preferably, very shortly after, before or substantially simultaneously, with step 1508, a menu (not shown), comprising the button of the button set corresponding to the currently played GOP structure, is made active for the duration of the video sequence currently being played. A test is performed, at step 1512, to determine whether or not a user event such as, for example, the “OK” button (not shown) has been depressed. If it is determined that a user event has occurred or has been detected, the corresponding button command is invoked at step 1514, which will involve adding an appropriate value to the GPRM. The associated LNK aspect of the command is also invoked at step 1514, which leads to the playing of the next video sequence at step 1516.

If the determination at step 1512 is negative, a test is performed at step 1518 to determine whether or not there are further GOP structures to process. If the determination at step 1518 is positive, a test is performed at step 1520 to determine whether the most recently processed GOP structure was the last GOP structure of the video sequence 1502. If the determination at step 1520 is negative, processing continues at step 1508 where the next GOP is retrieved and processed. However, if the most recently processed GOP structure was the last such structure of the video sequence 1502, a predetermined value, <value2>, is added to the GPRM at step 1522 and processing then continues at step 1508 where the first group of pictures structure GOP 1 is retrieved again.

If the determination at step 1518 is negative, it is determined at step 1524 whether the video sequence 1402 has been arranged to loop or repeat automatically. It will be appreciated in most preferred embodiments that the video sequence 1402 will be arranged to repeat whereupon processing continues from step 1520. However, if the video sequence is not arranged to repeat, processing terminates and the current value of the GPRM is used as the random number or at least as a seed for a random number generator or random number sequence generator.

In preferred embodiments, the above calculated number, that is, the number contained within the GPRM is used as a seed value for a LCG algorithm that is used to calculate a non-repeating sequence of pseudo-random numbers, that is, the generated sequence does not contain a repetition of any of the numbers until the whole of the sequence has been generated. However, once the full sequence has been generated, that full sequence will, itself, repeat. Preferably, the value contained within the GPRM is used as the first value, r₁, in the equation
rᵢ₊₁=(a.rᵢ+b) mod c,
where c is a prime number and a and b are constants selected according to a desired level of performance of the LCG, that is, according to the quality of the random numbers required.

It will be appreciated that embodiments can be realised in which multiple video sequences together with respective button sets as described above are used to generate the random number or respective random numbers such that the ultimately used random number is associated with or derived from data associated with those multiple video sequences or the embodiments are arranged to produce a number of random numbers using the multiple video sequences.

Although the above embodiments have been described with reference to an LCG, embodiments of the present invention are not limited to such LCGs. Embodiments can be realised in which other generators are used. For example, two or more LCGs can be combined to produce a Combined Linear Congruential Generator (CLCG) in which the two LCGs are combined usually by subtraction or ex-or. Still further, Recursive or Extended LCGs can be used to improve the randomness of low order bits that tend to be less random in LCGs. Other generators that might be used, having obtained a seed number, are Multiple Recursive Generators, Inverse Congruential Generators, Combined Inverse Congruential generators, Multiply with Carry Generators, Multiply or Single Feedback shift registers, Generalised Feedback Shift Registers including Twisted Feedback Shift Registers and Multiple GFSR and so on.

It will be appreciated that in the embodiments described in this specification, the term “audiovisual product” comprises at least any one of data from which audiovisual data can be derived, DVD video disc image data or other data compliant with the DVD specification and media storing or containing such data from which audiovisual data can be derived, DVD video disc image data or other data compliant with the DVD specification. In particular, it will be appreciated that the audiovisual product will take the form of data when it is accessed or distributed via a communication network.

Although a few preferred embodiments have been shown and described, it will be appreciated by those skilled in the art that various changes and modifications might be made without departing from the scope of the invention, as defined in the appended claims.

Although the above embodiments have been described with reference to the product being playable by a “standard DVD player”, it will be appreciated that other players can equally well be accommodated such as, for example, software players, set-top boxes or other means of processing or otherwise rendering audiovisual content using hardware or software or a combination of hardware and software. It will be appreciated that such players might preferably receive and process the audiovisual product in the form of data read from a storage medium or received via a communication link or channel of, for example, a network.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An authoring method for use in creating an audiovisual product, comprising the steps of:
defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realized AV assets and an expanded intermediate data structure of nodes and links, where each node is associated with an AV asset of the set and the links represent movement from one node to another; and
creating an audiovisual product in a predetermined output format, using the AV assets and the expanded intermediate data structure of the nodes and the links, wherein the audiovisual product is operable to facilitate random number generation.

2. The method of claim 1, wherein the defining step comprises defining at least one information component that comprises a reference to a raw content object.

3. The method of claim 2, wherein the reference denotes a file path to a location where the raw content object is stored.

4. The method of claim 1, wherein the defining step comprises defining at least one choice component comprising a reference to at least one raw content object, and at least one authoring parameter.

5. The method of claim 4, wherein the at least one authoring parameter is adapted to control a selection or modification of the at least one raw content object.

6. The method of claim 4, wherein the at least one authoring parameter comprises a runtime variable available during playback of the audiovisual product.

7. The method of claim 4, wherein the at least one authoring parameter comprises an authoring-only parameter that will not be available during playback of the audiovisual product.

8. The method of claim 4, wherein the choice component comprises a reference to a presentation template and a reference to at least one substitutable raw content object to be placed in the template according to the at least one authoring parameter.

9. The method of claim 1, wherein the defining step comprises defining at least one meta-component representing a set of components and transitions.

10. The method of claim 9, wherein the at least one meta-component is a procedurally defined representation of the set of components and transitions.

11. The method of claim 1, wherein each transition represents a permissible movement from one component to another component.

12. The method of claim 1, wherein each transition is associated with a triggering event.

13. The method of claim 12, wherein the triggering event is an event occurring during playback of the audiovisual product.

14. The method of claim 13, wherein the triggering event is receiving a user command, or expiry of a timer.

15. The method of claim 1, further comprising the step of checking expected conformance of the audiovisual product with the predetermined output format, using the plurality of components and the plurality of transitions.

16. The method of claim 15, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

17. The method of claim 15, wherein the checking step comprises predicting an expected total size of the audiovisual product, and comparing the expected total size against a storage capacity of a predetermined storage medium.

18. The method of claim 1, wherein the expanding step comprises, for each component, building one or more of the set of explicitly realised AV assets by reading and manipulating the one or more raw content objects.

19. The method of claim 18, wherein:
the defining step comprises defining at least one choice component comprising a reference to a plurality of raw content objects and at least one authoring parameter; and
the building step comprises:
selecting one or more raw content objects from amongst the plurality of raw content objects using the at least one authoring parameter; and
combining the selected raw content objects to form one of the AV assets.

20. The method of claim 19, comprising repeating the selecting and combining steps to automatically build a plurality of the explicitly realised AV assets from the one of the components.

21. The method of any preceding claim, wherein the expanding step comprises:
creating from each one of the plurality of components one or more explicitly realised AV assets to provide the set of AV assets;
creating the expanded intermediate data structure wherein each node represents one AV asset of the set; and
creating a set of links between the nodes.

22. The method of claim 1, wherein each transition is associated between first and second components, and creating the set of links comprises evaluating each transition to create one or more links, each of the links being between a node created from the first component and a node created from the second component.

23. The method of claim 1, wherein the expanding step comprises evaluating at least one of the transitions to create exit logic associated with at least one first node, evaluating one of the components to create entry logic associated with at least one second node, and providing a link between the first and second nodes according to the entry logic and the exit logic.

24. The method of claim 23, wherein at least one of the transitions is associated with a triggering event, and the expanding step comprises evaluating the triggering event to determine the exit logic associated with the at least first one node.

25. The method of claim 1, further comprising the step of checking expected conformance of the audiovisual product with the predetermined output format, using the AV assets and the expanded intermediate data structure of nodes and links.

26. The method of claim 25, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

27. The method of claim 26, wherein the checking step comprises predicting an expected total size of the audiovisual product, and comparing the expected total size against a storage capacity of a predetermined storage medium.

28. The method of claim 1, wherein the AV assets have a data format specified according to the predetermined output format.

29. The method of claim 1, wherein the AV assets each have a data format according to the predetermined output format, whilst the raw content objects are not limited to a data format of the predetermined output format.

30. The method of claim 1, wherein the predetermined output format is a DVD-video specification.

31. The method of claim 1, wherein the AV assets each comprise a video object, zero or more audio objects, and zero or more sub-picture objects.

32. The method of claim 1, wherein the AV assets each comprise at least one video object, zero to eight audio objects, and zero to thirty-two sub-picture objects, according to the DVD-video specification.

33. The method of claim 1, wherein the creating step comprises creating objects in a hierarchical data structure defined by the predetermined output format with objects at levels of the data structure, according to the intermediate data structure of nodes and links, and where the objects in the hierarchical data structure include objects derived from the explicitly realized AV assets.

34. The method of claim 1, wherein the predetermined output format is a DVD-video specification and the creating step comprises creating DVD-video structure locations from the nodes of the expanded intermediate data structure, placing the explicitly realised AV assets at the created structure locations, and substituting the links of the expanded intermediate data structure with explicit references to the DVD-video structure locations.

35. An authoring method for use in creating at least one of an audiovisual product or a DVD-video product, comprising the steps of:
creating a plurality of components representing parameterized sections of audiovisual content, and a plurality of transitions representing movements between components;
expanding the plurality of components and the plurality of transitions to provide a set of AV assets and an expanded data structure of nodes and links, where each node is associated with an AV asset of the set and the links represent movement from one node to another; and
creating a DVD-video format data structure from the AV assets, using the nodes and links, wherein the audiovisual product or DVD-video product is operable to facilitate random number generation.

36. The method of claim 35, comprising creating at least one information component comprising a reference to an item of AV content.

37. The method of claim 35, comprising creating at least one choice component comprising a reference to at least one item of AV content, and at least one parameter for modifying the item of AV content.

38. The method of claim 37, wherein the choice component comprises a reference to a presentation template and a reference to at least one item of substitutable content to be placed in the template according to the at least one parameter.

39. The method of claim 37, wherein the choice component comprises at least one runtime variable available during playback of an audiovisual product in a DVD player, and at least one authoring parameter not available during playback.

40. The method of claim 35, comprising creating at least one meta-component representing a set of components and transitions.

41. The method of claim 35, wherein each transition represents a permissible movement from one component to another component, each transition being associated with a triggering event.

42. The method of claim 41, wherein a triggering event includes receiving a user command, or expiry of a timer.

43. The method of claim 35, wherein the expanding step comprises:
creating from each one of the plurality of components one or more AV assets to provide the set of AV assets;
creating the expanded data structure wherein each node represents one AV asset of the set; and
creating a set of links between the nodes.

44. The method of claim 37, wherein the expanding step comprises evaluating each choice component to create a plurality of AV assets according to each value of the at least one parameter.

45. The method of claim 44, wherein evaluating each choice component comprises creating entry logic associated with at least one node and/or evaluating at least one transition to create exit logic associated with at least one node, and providing a link between a pair of nodes according to the entry logic and the exit logic.

46. The method of claim 35, comprising the step of checking expected conformance with the DVD-video format using the created components and transitions.

47. The method of claim 35, comprising the step of checking expected conformance with the DVD-video format using the set of AV assets and the expanded data structure of nodes and links.

48. An authoring method for use in creating an audiovisual product according to a DVD-video specification, comprising the steps of:
generating a set of AV assets each comprising a video object, zero or more audio objects and zero or more sub-picture objects, and an expanded data structure of nodes and links, where each node is associated with one AV asset of the set and the links represent navigational movement from one node to another; and
creating a DVD-video format data structure from the set of AV assets, using the nodes and links;
the method characterized by the steps of:
creating a plurality of components and a plurality of transitions, where a component implicitly defines a plurality of AV assets by referring to a presentation template and to items of raw content substitutable in the presentation template, and the plurality of transitions represent navigational movements between components; and
expanding the plurality of components and the plurality of transitions to generate the set of AV assets and the expanded data structure of nodes and links, wherein the audiovisual product is operable to facilitate random number generation.

49. A storage or recording medium storing computer executable instructions for performing the method of claim 1.

50. A storage or recording medium storing computer executable instructions for performing the method of claim 35.

51. A storage or recording medium storing computer executable instructions for performing the method of claim 48.

52. A storage or recording medium storing an audiovisual product authored according to the method of claim 1.

53. A storage or recording medium storing an audiovisual product authored according to the method of claim 35.

54. An optical disk recording medium having recorded thereon an audiovisual product authored according to the method of claim 48.

55-57. (canceled).

58. A method as claimed in claim 1 wherein the audiovisual product comprises data representing a video sequence and a number of associated data each having a corresponding command to be invoked in response to at least one event and data to derive a first output value from or associated with an invoked command.

59. A method as claimed in claim 58 wherein the data representing the video sequence comprises a plurality of data structures; each of the data structures being associated with a respective one of the corresponding commands.

60. A method as claimed in claim 59 in which the plurality of data structures comprises a plurality of Group-of-Pictures structures.

61. A method as claimed in claim 58 in which the associated data comprises at least a command to influence the operation of at least one of a navigation engine and a presentation engine.

62. A method as claimed in claim 58 in which the corresponding commands comprise associated values used to produce the first value.

63. A method as claimed in claim 58 in which the corresponding commands comprise respective navigation commands associated with data representing a further video sequence.

64. A method as claimed in claim 63 in which the navigation commands retrieve the data representing the further video sequence and cause the presentation engine to derive the further video sequence from the data representing the further video sequence.

65. A method as claimed in claim 58 in which the means to derive the first value comprises a register arranged to store a time varying value during the output of the video sequence by the presentation engine.

66. A method as claimed in claim 65 in which the register is a GPRM register set to counter mode.

67. A method as claimed in claim 66 in which the means to derive the first value comprises a combiner to combine the time varying value of the register with data associated with the invoked command.

68. A method as claimed in claim 67 in which the combiner comprises an adder to add the time varying value of the register to the data associated with the invoked command.

69. A method as claimed in claim 58 in which the means to derive the first value further comprises means to derive the first value from an initialisation value.

70. A method as claimed in claim 68 in which the initialisation value is generated by a random number generator.

71. A method as claimed in claim 70 in which the means to generate a sequence of values from the first value.

72. A method as claimed in claim 71 in which the means to generate the sequence comprises means to generate the sequence with a predeterminable number of non-repeating values.

73. A method as claimed in claim 71 in which the means to generate the sequence comprises a calculator to perform an iterative operation to calculate the values of the sequence.

74. A method as claimed in claim 73 in which iterative operation calculates rᵢ₊₁=arᵢ+b mod c, where a and b are constants, r₁ is the first value and c is prime.

75. A method as claimed in claim 1 further comprising the step of creating or obtaining data representing a video sequence and a number of associated data each having a corresponding command to be invoked in response to at least one event and data to derive a first output value from or associated with an invoked command.

76. A method as claimed in claim 75 wherein the step of creating or obtaining the data representing the video sequence comprises creating or obtaining a plurality of data structures; each of the data structures being associated with a respective one of the corresponding commands.

77. A method as claimed in claim 76 in which the step of creating or obtaining the plurality of data structures comprises creating or obtaining a plurality of Group-of-Pictures structures.

78. A method as claimed in claim 75 in which the step of creating or obtaining the associated data comprises the step of creating or obtaining at least a command to influence the operation of at least one of a navigation engine and a presentation engine.

79. A method as claimed in claim 75 in which the step of creating or obtaining the corresponding commands comprise the step of creating or obtaining associated values used to produce the first value.

80. A method as claimed in claim 75 in which the step of creating or obtaining corresponding commands comprise the step of creating or obtaining respective navigation commands associated with data representing a further video sequence.

81. A method as claimed in claim 80 in which the step of creating or obtaining the navigation commands comprises the step of creating or obtaining commands to retrieve the data representing the further video sequence and cause the presentation engine to derive the further video sequence from the data representing the further video sequence.

82. A method as claimed in claim 75 in which the step of creating means to derive the first value comprises the step of creating or obtaining a register arranged to store a time varying value during the output of the video sequence by the presentation engine.

83. A method as claimed in claim 82 in which the register is a GPRM register set to counter mode.

84. A method as claimed in claim 83 in which the step of creating or obtaining means to derive the first value comprises the step of creating or obtaining a combiner to combine the time varying value of the register with data associated with the invoked command.

85. A method as claimed in claim 84 in which the step of creating or obtaining a combiner comprises the step of creating or obtaining an adder to add the time varying value of the register to the data associated with the invoked command.

86. A method as claimed in claim 85 in which the step of creating or obtaining means to derive the first value further comprises the step of creating or obtaining means to derive the first value from an initialisation value.

87. A method as claimed in claim 86 in which the step of obtaining or creating means to derive the first value from an initialization value comprises the step of generating the initialization value using a random number generator.

88. A method as claimed in claim 75 in further comprising the step of creating or generating means to generate a sequence of values from the first value.

89. A method as claimed in claim 88 in which the step of creating or obtaining means to generate the sequence comprises the step of obtaining or creating means to generate the sequence with a predeterminable number of non-repeating values.

90. A method as claimed in claim 89 in which the step of creating or obtaining means to generate the sequence comprises the step of creating or obtaining a calculator to perform an iterative operation to calculate the values of the sequence.

91. A method as claimed in claim 90 in which step of creating or obtaining a calculator to perform the iterative operation comprises the step of creating or obtaining means to calculate rᵢ₊₁=ar₁+b mod c, where a and b are constants, r₁ is the first value and c is prime.

92. A data processing system comprising a reader to read data representing a video sequence and a number of associated data each having a corresponding command; a presentation engine for outputting the video sequence derived from the data representing the video sequence, a navigation engine, responsive to an event, to invoke one of the corresponding commands according to the output of the video sequence; and means to derive a first value from the invoked command of the corresponding commands.

93. A data processing system as claimed in claim 92 in which the data representing the video sequence comprises a plurality of data structures; each of the data structures being associated with a respective one of the corresponding commands.

94. A data processing system as claimed in claim 93 in which the plurality of data structures comprises a plurality of Group-of-Pictures structures.

95. A data processing system as claimed in claim 92 in which the associated data comprises at least a command to influence the operation of at least one of the navigation engine and the presentation engine.

96. A data processing system as claimed in claim 92 in which the corresponding commands comprise associated values used to produce the first value.

97. A data processing system as claimed in claim 92 in which the corresponding commands comprise respective navigation commands associated with data representing a further video sequence.

98. A data processing system as claimed in claim 97 in which the navigation commands retrieve the data representing the further video sequence and cause the presentation engine to derive the further video sequence from the data representing the further video sequence.

99. A data processing system as claimed in claim 92 in which the means to derive the first value comprises a register arranged to store a time varying value during the output of the video sequence by the presentation engine.

100. A data processing system as claimed in claim 99 in which the register is a GPRM register set to counter mode.

101. A data processing system as claimed in claim 99 in which the means to derive the first value comprises a combiner to combine the time varying value of the register with data associated with the invoked command.

102. A data processing system as claimed in claim 101 in which the combiner comprises an adder to add the time varying value of the register to the data associated with the invoked command.

103. A data processing system as claimed in claim 92 in which the means to derive the first value further comprises means to derive the first value from an initialization value.

104. A data processing system as claimed in claim 103 in which the initialization value is generated by a random number generator.

105. A data processing system as claimed in claim 92 in further comprising means to generate a sequence of values from the first value.

106. A data processing system as claimed in claim 105 in which the means to generate the sequence comprises means to generate the sequence with a predeterminable number of non-repeating values.

107. A data processing system as claimed in claim 105 in which the means to generate the sequence comprises a calculator to perform an iterative operation to calculate the values of the sequence.

108. A data processing system as claimed in claim 107 in which iterative operation calculates rᵢ₊₁=arᵢ+b mod c, where a and b are constants, r₁ is the first value and c is prime.

109. A storage medium comprising data representing a video sequence and a number of associated data each having a corresponding command; and data to derive a first value from one of the corresponding commands in response to an event.

110. A storage medium as claimed in claim 109 in which the data representing the video sequence comprises a plurality of data structures; each of the data structures being associated with a respective one of the corresponding commands.

111. A storage medium as claimed in claim 110 in which the plurality of data structures comprises a plurality of Group-of-pictures structures.

112. A storage medium as claimed in claim 111 in which the associated data comprises at least a command to influence the operation of at least one of a navigation engine and a presentation engine.

113. A storage medium as claimed in claim 109 in which the corresponding commands comprise respective navigation commands associated with data representing a further video sequence.

114. A storage medium as claimed in claim 109 in which the navigation commands retrieve the data representing the further video sequence and cause the presentation engine to derive the further video sequence from the data representing the further video sequence.

115. A storage medium as claimed in claim 109 further comprising a command to arrange for a register to produce a time varying value during output of the video sequence by the presentation engine.

116. A storage medium as claimed in claim 115 in which the command to arrange for the register to produce the time varying value comprises a command to cause a GPRM to assume a counter mode.

117. A storage medium as claimed in claim 115 further comprising data to derive a first value, in response to an event, from one of the corresponding commands.

118. A storage medium as claimed in claim 117 in which the data to derive the first value further comprises data to derive the first value from an initialisation value.

119. A storage medium as claimed in claim 118 in which the initialisation value is generated by a random number generator.

120. A storage medium as claimed in claim 115 further comprising data to generate a sequence of values from the first value.

121. A storage medium as claimed in claim 120 in which the data to generate the sequence comprises data to generate a sequence comprising a predeterminable number of non-repeating values.

122. A storage medium as claimed in claim 120 in which the data to generate the sequence comprises a command to perform an iterative operation to calculate the values of the sequence.

123. A storage medium as claimed in claim 122 in which the iterative operation calculates rᵢ₊₁=arᵢ+b mod c, where a and b are constants, r₁ is the first value and c is prime.

124. A storage medium as claimed in claim 109, in which the medium is a DVD disc or other optical disc.

125. A data processing system comprising means to play an interruptible or skipable video sequence; and a random number generator for generating a random number associated with an interruption of the interruptible or skipable video sequence.

126. A data processing method comprising the steps of playing an interruptible or skipable video sequence; and generating a random number associated with an interruption of the interruptible or skipable video sequence.

127 and 128 (cancelled).
